(19) United States
(12) Patent Application Publication
(10) Pub. No.: US 2026/0346269 A1
(43) Pub. Date: Nov. 5, 2026

(54) CENTRIFUGE ASSEMBLY, SYSTEM AND METHODS

(71) Applicant: THERMO ELECTRON SAS, Villebon-sur-Yvette (FR)

(72) Inventor: Benoit LIMON, Villebon-sur-Yvette (FR)

(21) Appl. No.: 19/484,584

(22) PCT Filed: May 15, 2024
(86) PCT No.: PCT/EP2024/063438

§ 371 Date: Nov. 14, 2025

(30) Foreign Application Priority Data
May 17, 2023 (EP) 23315203.2

(51) Int. Cl. B04B 5/04; B04B 9/10; B04B 13/00

(52) U.S. Cl. CPC B04B 5/0442; B04B 9/10; B04B 13/00; B04B 2005/0492

(57) ABSTRACT

A centrifuge assembly is provided. The centrifuge assembly comprises: a rotor, rotationally mounted about an axis of rotation. The rotor comprises a first rotor port and a second rotor port, the second rotor port radially spaced from the first rotor port with respect to the axis of rotation. The centrifuge further comprises: an inlet port and an outlet port; and valving. The valving is configured to selectively fluidically connect: the inlet port with the first rotor port and the outlet port with the second rotor port in a first configuration of the valving; or the inlet port with the second rotor port and the outlet port with the first rotor port in a second configuration of the valving.

### BACKGROUND

The present disclosure relates to a centrifuge assembly, along with a corresponding system, method of operation and method of calibration.

It is known to use centrifuge systems to concentrate, wash and recover live cells from culture media and dead cells. These systems include a centrifuge which can be operated in both a counter-flow direction (fluid moves in an opposite direction to the centrifugal force) and an in-flow direction (fluid moves in the same direction as the centrifugal force).

Typically, the centrifuge includes first and second ports. To operate in the counter-flow direction fluid is fed into the first port and recovered from the second port, and to operate in the in-flow direction fluid is fed into the second port and recovered from the first port. To achieve this, the direction of fluid flow around the system is switched. Typically this will be by reversing a direction of a pump in the system.

As a result, each of the first port and the second port can effectively be an outlet port. This means that, for example, if measurement of the outlet is required there must be duplication of components and increased complexity.

U.S. Pat. No. 9,090,910 B2 discloses methods and systems for manipulation of media and particles, whether inert materials or biomaterials, such as cells in suspension cell culture. The methods and systems comprise use of an apparatus comprising a rotating chamber wherein actions of combined forces fluid flow force and centrifugal force form a fluidized bed within the rotating chamber. The arrangement uses a pump which is reversed to drive fluid through the centrifuge for cell concentration and washing.

U.S. Pat. No. 9,839,920 discloses an apparatus for manipulating particles which includes: a rotor rotatable at a speed about an axis, the rotor having an outer periphery and front and rear opposite sides; at least one chamber mounted on the rotor, each chamber having an inlet and an outlet; an umbilical assembly rotatable about the axis; and a drive mechanism configured to rotate the umbilical assembly at about one-half the speed of the rotor. The umbilical assembly includes: a curvilinear guide tube connecting to a drum at a rear side of the rotor; a flexible conduit residing in the guide tube; and first and second elongate passageways for each chamber extending through the conduit, wherein the first passageway is in fluid communication with the inlet of a respective chamber and the second passageway is in fluid communication with the outlet of the respective chamber. The passageways are held in a spaced-apart relationship relative to one another. The arrangement uses a pump which is reversed to drive fluid through the centrifuge for cell concentration and washing.

US 2020 0297911 A1 discloses a chamber configuration for a reverse flow centrifuge, and a reverse flow centrifuge system configured for low fluid volume and small radius rotation. The compact reverse flow centrifuge system has a reusable subsystem and a single use replaceable subsystem. The replaceable subsystem comprises a separation chamber, fluid delivery manifold and rotational mounting connecting the separation chamber to the fluid manifold. The single use replaceable subsystem provides a closed environment for execution of reverse flow centrifugation processes. The separation chamber has a substantially conical fluid enclosure portion connected to a neck portion, and a dip tube extends centrally through the conical fluid enclosure to provide a fluid path to the tip of the conical fluid enclosure. There is no disclosure of valving to switch between counter-flow and in-flow regimes.

US 2021 0046489 A1 discloses a fluid recovery system and method for use with concentrator systems for concentrating particles suspended in a fluid and where this suspension is recovered from a fluid stream drawn from the concentrator system. A controller is configured to control valve actuation to direct concentrate being drawn from the concentrator chamber through a recovery tube to a recovery reservoir based on fluid volume movement. The system can use a density sensor to detect density transitions in fluid in the fluid recovery tube to identify leading and trailing edges of a portion of concentrated particles in fluid suspension passing through the recovery tube and actuate recovery valves based on objectives for maximising particle recovery with minimal dilution. There is no disclosure of valving to switch between counter-flow and in-flow regimes.

There is therefore a need for an improved centrifuge assembly.

### SUMMARY

A centrifuge assembly is provided according to claim 1. This allows a simple system to be used with a clear inlet port and outlet port.

The centrifuge assembly may further comprise a pump fluidically connected to the inlet port upstream of the valving, the pump for driving fluid through the rotor. This is an effective way to move fluid through the centrifuge assembly.

The pump may be configured to only drive fluid in a single direction. That is, the pump may be non-reversible and/or only configured to operate in a single direction. The centrifuge assembly allows such a pump to be used.

The pump may be the only pump in a flow loop defined between the outlet port and the inlet port. It is not necessary to use a separate pump in an opposite direction with the centrifuge assembly.

The centrifuge assembly may further comprise a cell density sensor fluidically connected to the outlet port downstream of the valving. As the outlet port always acts as an outlet, measurements here will always be appropriate.

The cell density sensor may comprise: a capacitance sensor; an optical absorbance sensor; and/or a scattered light sensor. Such sensors can be suitable to identifying live cells.

The cell density sensor may be the only cell density sensor in a flow loop defined between the outlet port and the inlet port. As the outlet port always acts as an outlet, there is no need for further cell density sensors.

The centrifuge assembly may further comprise: a processor in communication with the cell density sensor to receive a signal, the processor configured to adjust one or more operating parameters of the centrifuge assembly in response to the signal. The present system allows for further automatization of the centrifuge assembly.

The operating parameters may comprise: a rotational speed of the rotor; a fluid inlet rate to the inlet port; the configuration of the valving. These are the primary parameters to control operation of the centrifuge assembly. Fluid inlet rate may be controlled by varying a pump speed.

The valving may comprise: first valving for selectively fluidically connecting the inlet port with the first rotor port or the second rotor port; and second valving for selectively fluidically connecting the outlet port with the second rotor port or the first rotor port. Each set of valving can be independently controlled to route fluid through the centrifuge assembly.

The first valving may comprise: a first valve between the inlet port and the first rotor port; and a second valve between the inlet port and the second rotor port. The second valving may comprise: a third valve between the outlet port and the second rotor port; and a fourth valve between the outlet port and the first rotor port. Wherein: in the first configuration the first valve is open, the second valve is closed, the third valve is open and the fourth valve is closed; and in the second configuration the first valve is closed, the second valve is open, the third valve is closed and the fourth valve is open. This is an effective arrangement of valving for to appropriately route fluid through the centrifuge assembly.

The rotor may comprise a plurality of first rotor ports and second rotor ports, each second rotor port radially spaced from the corresponding first rotor port with respect to the axis of rotation. Multiple rotor ports mean that there may be multiple containers and hence more product can be processed at the same time.

The valving may be configured to selectively fluidically connect: the inlet port with each first rotor port and the outlet port with each second rotor port in the first configuration of the valving; or the inlet port with each second rotor port and the outlet port with each first rotor port in the second configuration of the valving. This allows each set of ports to be used in accordance with the present disclosure.

Each second rotor port may be radially closer to axis of rotation than the corresponding first rotor port. This arrangement can be used to achieve the counter-flow and in-flow regimes.

A system is provided according to claim 15. This system can be used to take advantage of the centrifuge assembly discussed herein.

The system may further comprise a cut-off valve between the inlet line and the outlet line. This can allow the inlet line and outlet line to be selectively connected, for example during a cleaning operation.

A method of operating the centrifuge assembly is provided according to claim 17. This method can be used to take advantage of the centrifuge assembly discussed herein.

The centrifuge assembly may further comprise a cell density sensor fluidically connected to the outlet port downstream of the valving, and the method further comprises the steps of: with the valving in the first configuration sensing an output parameter of the fluid with the cell density sensor; and with the valving in the second configuration sensing an output parameter of the fluid with the cell density sensor. Again, the method allows for automation of the operation.

The fluid may be a mixture of one or more of: live cells; dead cells; and/or culture medium, and each second rotor port is radially closer to axis of rotation than the corresponding first rotor port, wherein: the step of operating the pump in a first direction with the valving in the first configuration to drive fluid to the inlet port then the first rotor port and then the second rotor port is to capture live cells in the rotor and elutriate dead cells and culture medium; operating the pump in the first direction with the valving in the second configuration to drive fluid to the inlet port then the second rotor port and then the first rotor port is to recover live cells from the rotor. The present centrifuge assembly is particularly useful for processing such fluids.

A method of calibrating the centrifuge assembly is provided according to claim 20. This method allows for only an optical absorbance sensor to be used as the cell density sensor.

The method may further comprise the steps of: increasing the pump speed in the first direction; identifying a change in the measured optical absorbance; comparing the background noise to a second optical absorbance before the change in the measured optical absorbance. This allows for the background noise value to be checked or verified.

The cell density sensor may be an optical absorbance sensor and the fluid is a mixture of live cells and dead cells, the method further comprising the steps of: with the valving in the second configuration, subtracting a background noise from a measured optical absorbance to determine the output parameter of the fluid, wherein the background noise is calculated according to the method described herein. This means that an amount of live cells being sensed can be detected with the optical absorbance sensor.

A container for a centrifuge or centrifuge assembly is provided according to clause 23. This container is particularly advantageous in set-ups where a single pump is used and allows for stable flow therethrough.

The head portion may be generally conical, with a base diameter greater than a diameter of the elongate stem. This geometry can help achieve stable flow distribution.

The diameter of the elongate stem may be between 20% to 30% of the base diameter. This geometry can help achieve stable flow distribution.

The head portion may have a cone angle between 70° and 85°. This geometry can help achieve stable flow distribution.

The head portion may comprise a first conical shape extending from the base to the apex, and a second conical shape tapering from the base to the elongate stem. This geometry can help achieve stable flow distribution.

The head portion may have a head portion length and the first conical shape may have a length which is at least 70% of the head portion length. This geometry can help achieve stable flow distribution.

The container may have a length, and the elongate stem has a length which is at least 40% of the length of the container. This geometry can help achieve stable flow distribution.

The elongate stem may have a length of at least 5 centimetres. This geometry can help achieve stable flow distribution.

The container may have a length, and the elongate stem may have a length which is at least 40% of the length of the container. This geometry can help achieve stable flow distribution.

The elongate stem may have a length of at least 5 centimetres. This is a suitable length for stable flow distribution.

A centrifuge or centrifuge assembly is provided according to clause 31. The single pump drives fluid into each of the containers, and the container shape allows for reliable processing using the centrifuge. This can use the valving discussed herein.

### BRIEF DESCRIPTION OF THE DRAWINGS

The present specification makes reference to the accompanying drawings, by way of example only, in which:

FIG. 1 shows a schematic of a centrifuge assembly;

FIG. 2 shows a schematic of a system including the centrifuge assembly of FIG. 1;

FIGS. 3A to 3K show a series of schematics of the system of FIG. 2 being operated;

FIG. 4A to 4B show a series of schematics of the system of FIG. 2 being calibrated; and

FIG. 5 shows an isolated side partial cross-sectional view of an centrifuge rotor having an improved container attached thereto.

### DETAILED DESCRIPTION

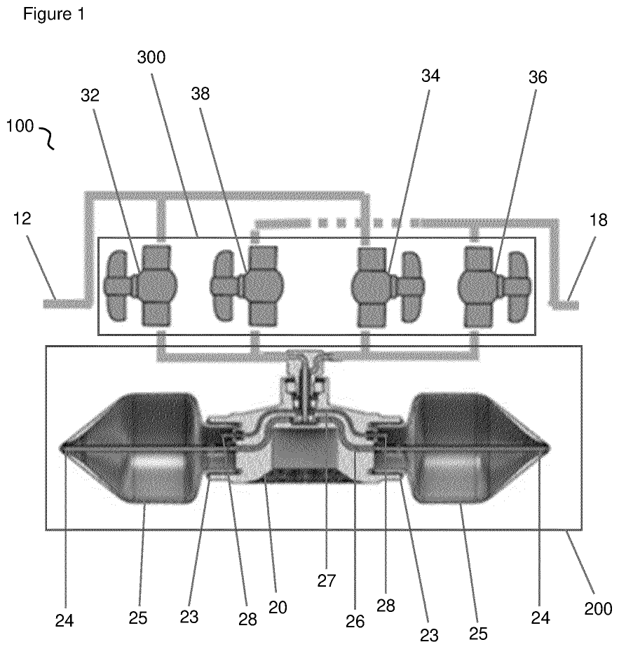

FIG. 1 shows an isolated schematic of the centrifuge assembly 100. While this Figure shows the basic elements of the centrifuge assembly 100 it is appreciated that there may be additional components in this centrifuge assemble 100 which are not shown in FIG. 1.

The centrifuge assembly 100 comprises a rotor 20. In certain examples, the rotor 20 may be formed partially or entirely by one or more rotor inserts. Any of the discussions herein in relation to the rotor 20 may instead refer to a rotor insert. Specifically, any feature discussed herein in relation to the rotor 20 may be a feature of a rotor insert used in such a rotor 20. The rotor 20 is rotationally mounted about an axis of rotation. This axis of rotation may be anywhere appropriate for the rotor 20. In certain examples, this may be at a centre of the rotor 20 in plan view. For example, the rotor 20 may be generally circular in plan view, with the axis of rotation at a centre of the rotor 20. In any event, the rotor 20 is rotatable about this axis of rotation. This rotation can be driven by any suitable driving apparatus, such as an electric motor.

The rotor 20 may be rotationally mounted in this manner in a centrifuge 200. The rotor 20 may comprise one or more container mountings 23 for attaching a container 25 to the rotor 20. For example, the container mounting 23 may be a threaded element, with a corresponding threaded element on the container 25. FIG. 1 shows an example where the container mounting 23 is a female threaded section, and the container 25 has corresponding male threaded section. Of course, the threaded sections could be reversed. Any other suitable container mounting 23 may also be used, including but not limited to a push-fit connection, pin and bore, etc.

The rotor 20 comprises a first rotor port 24 and a second rotor port 28. Each of the first rotor port 24 and the second rotor port 28 are arranged to deliver a fluid to the container 25 when attached to the container mounting 23. The first rotor port 24 and second rotor 28 may, therefore, be identified as components of the container mounting 23. The second rotor port 28 is radially spaced from the first rotor port 24 with respect to the axis of rotation. In other words, one of the first rotor port 24 or the second rotor port 28 is closer to the axis of rotation than the other of the second rotor port 28 or the first rotor port 24.

FIG. 1 shows an example in which the first rotor port 24 is radially further from the axis of rotation than the second rotor port 28. In other words, the second rotor port 28 is radially closer to the axis of rotation than the first rotor port 24. An alternative arrangement is also considered with this reversed.

The rotor 20 may comprise a first fluid passageway 26. This first fluid passageway 26 can comprise the first rotor port 24. The rotor 20 may comprise a second fluid passageway 27. This second fluid passageway 27 can comprise the second rotor port 28.

As can be seen in FIG. 1, the rotor 20 may comprise a plurality of container mountings 23. Each container mounting 23 is suitable for attaching a container 25 to the rotor 20. Each container mounting 23 may have its own first rotor port 24 and second rotor port 28.

The rotor 20 may comprise a first fluid passageway 26 and second fluid passageway 27 for each container mounting 23. The plurality of container mountings 23 may be connected in parallel in which each first fluid passageway 26 is connected directly to the inlet port 12 and each second fluid passageway 27 is connected directly to the outlet port 18.

In other configurations each container mounting 23 may be connected in series. The first fluid passageway 26 of the first container mounting 23 may be directly connected to the inlet port 12. The second fluid passageway 27 of the first container mounting 23 may be directly connected to the first fluid passageway 26 of an adjacent container mounting, and so on. The final container mounting 23 of the rotor has its second fluid passageway 26 in direct connection with the outlet port 18.

The following disclosure will refer to “the” first rotor port 24 and “the” second rotor port 28. However, it is equally applicable to an arrangement with multiple container mountings 23. In such an arrangement the reference to “the” first rotor port 24 may correspond to “each” first rotor port 24, and the reference to “the” second rotor port 28 may correspond to “each” second rotor port 28.

The centrifuge assembly 100 comprises an inlet port 12 and an outlet port 18. The inlet port 12 and outlet port 18 may be dedicated connections, such as push-fit connections. Alternatively, the inlet port 12 and outlet port 18 may be conceptional sections of pipework for the centrifuge assembly 100. The inlet port 12 receives a flow of fluid to pass into the rotor 20. The outlet port 18 expels a flow of fluid from the rotor 20.

The centrifuge assembly 100 further comprises valving 300. The valving 300 is selectively switchable between a first configuration and a second configuration.

In general, the valving 300 is for changing flow through the rotor 20 from a counter-flow regime and an in-flow regime. As the rotor 20 spins about the axis of rotation, a centrifugal force is experienced by fluid in containers 25 attached to the container mounting 23. This centrifugal force is in a radially-outward direction away from the axis of rotation. As noted, the first rotor port 24 and second rotor port 28 are radially spaced from one another. In use, fluid can flow from the radially-outer port (in FIG. 1 the first rotor port 24) to the radially-inner port (in FIG. 1 the second rotor port 28), which is identified as a counter-flow regime. Fluid can alternatively flow from the radially-inner port to the radially-outer port, which is identified as an in-flow regime. The following description of the flow regimes is on the basis of the radially-outer and -inner ports being as shown in FIG. 1, but is equally applicable to the opposite arrangement with the appropriate modifications.

The valving 300 is used to selectively route fluid flow which enters the inlet port 12 into either the first rotor port 24 (counter-flow regime) or the second rotor port 28 (in-flow regime) and hence into the container 25. The valving 300 is also used to correspondingly route fluid flow from the container 25 via the second rotor port 28 (counter-flow regime) or the first rotor port 24 (in-flow regime) to the outlet port 18. In other words, the same inlet port 12 and outlet port 18 can be used for both the counter-flow regime and the in-flow regime

In the first configuration of the valving 300, the inlet port 12 is fluidically connected to the first rotor port 24, and the outlet port is fluidically connected to the second rotor port 28. While the centrifuge assemble 100 may be used in an loop system in which all ports are ultimately fluidically connected about the loop, it is which of the first rotor port 24 and the second rotor port 28 that fluid flow into the inlet port 12 first is transmitted to.

The valving 300 may be any suitable configuration which achieves this switching between the first configuration and the second configuration. FIG. 1 shows one such example of suitable valving 300.

The valving 300 of FIG. 1 is made of first valving and second valving. The first valving selectively fluidically connects the inlet port 12 to either the first rotor port 24 or the second rotor port 28. The second valving fluidically connects the outlet port 18 to either the second rotor port 28 or the first rotor port 24. The second valving may connect to the other of the second rotor port 28 or first rotor port 24 than the first valving. That is, if the first valving is connecting the inlet port 12 to the first rotor port 24 then the second valving may connect the outlet port 18 to the second rotor port 28, or vice versa.

The first valving may comprise a first valve 32 and a second valve 34. The second valving may comprise a third valve 36 and a fourth valve 38. Each of these valves 32, 34, 36, 38 is able to inhibit/prevent fluid flow therethrough.

The first valve 32 is connected between the inlet port 12 and the first rotor port 24. The second valve 34 is connected between the inlet port 12 and the second rotor port 28. The third valve 36 is connected between the second rotor port 28 and the outlet port 18. The fourth valve 38 is connected between the first rotor port 24 and the outlet port 18.

In the first configuration, the first valve 32 is open and the second valve 34 is closed. This means that fluid flowing into the inlet port 12 is directed to the first rotor port 24. The third valve 36 is open and the fourth valve 38 is closed. This means that fluid flows into the second rotor port 28 and then out of the outlet port 18. This is the counter-flow regime.

In the second configuration, the first valve 32 is closed and the second valve 34 is open This means that fluid flowing into the inlet port 12 is directed to the second rotor port 28. The third valve 36 is closed and the fourth valve 38 is open, This means that fluid flows into the first rotor port 24 and then out of the outlet port 18. This is the in-flow regime.

While FIG. 1 shows each valve 32, 34, 36, 38 as being entirely independently operable, this is not necessarily the case. For example, there may be one or more components shared across multiple valve 32, 34, 36, 38. This could be for example an element which can block fluid flow through more than one valve 32, 34, 36, 38. For example, when the first valve 32 is opened this may simultaneously close the second valve 34 and/or the fourth valve 38. There may be, for example, a member which blocks fluid flow in the valves 32, 34, 36, 38. This member may be moved out of the way of fluid flow in the first valve 32 and into the flow path of fluid through the second valve 34 and/or the fourth valve 38.

In further examples, the first valving or second valving may comprise a valve with a single inlet and two outlets. Further example valving 300 may include one or more valves with multiple inputs and a single output. Such valving 300 can equally be used to achieve the switching of the present disclosure.

In this sense, a single inlet port 12 and a single outlet port 18 may be used. The inlet port 12 always acts as a fluid inlet, and the outlet port 18 always acts as a fluid outlet. However, the flow of fluid through the rotor 20 can be easily switched between a counter-flow regime and an in-flow regime. In this sense, fluid can be delivered to the centrifuge assembly 100 in a single direction (into the inlet port 12) and hence there is no need to reverse a direction of the fluid flow as in the prior art.

The centrifuge assembly 100 may further comprise a pump 14. This pump 14 can be of any suitable type. In particular examples, the pump 14 may be a non-contact pump whereby the mechanical parts of the pump 14 do not come into direct contact with fluid passing therethrough. For example, the pump 14 maybe a peristaltic pump (or roller pump) where one or more wipers or rollers progressive compress a flexible tube to drive fluid through the tube.

The pump 14 may be arranged upstream of the valving 300, connected (in certain examples with intermediate components) to the inlet port 12. By “upstream” it is meant that in an opposite direction to a flow of fluid through the centrifuge assembly 100. In other words, the fluid passes through the pump 14 and then the valving 300. As explained above, the valving 300 then acts to direct the flow of fluid in either a counter-flow regime or an in-flow regime through the rotor 20. As a result, the pump 14 can operate to pump fluid in a single direction (the downstream direction, towards the valving 300), while the valving 300 is used to change how that single direction of pumping is directed through the rotor 20. This allows the pump 14 to be configured to only drive the fluid in this single, downstream, direction. The pump 14 may be non-reversible, or at least configured such that in a predefined mode of operation it does not reverse. Such predefined mode of operation may be a mode of operation, during which cells are processed by the centrifuge assembly 100, in particular, if processed cells will be utilized later. A cell processing mode of operation may include one or more of: forming a fluidized bed, capturing cells, washing the cells and recovering the cells.

Cell processing modes however may not include a priming mode, during which a pump 14 may be reversed to prepare a bubble trap. Also, a mode of flushing the centrifuge assembly 100 to clean the centrifuge assembly 100 after cell processing may also not be considered a cell processing mode of operation.

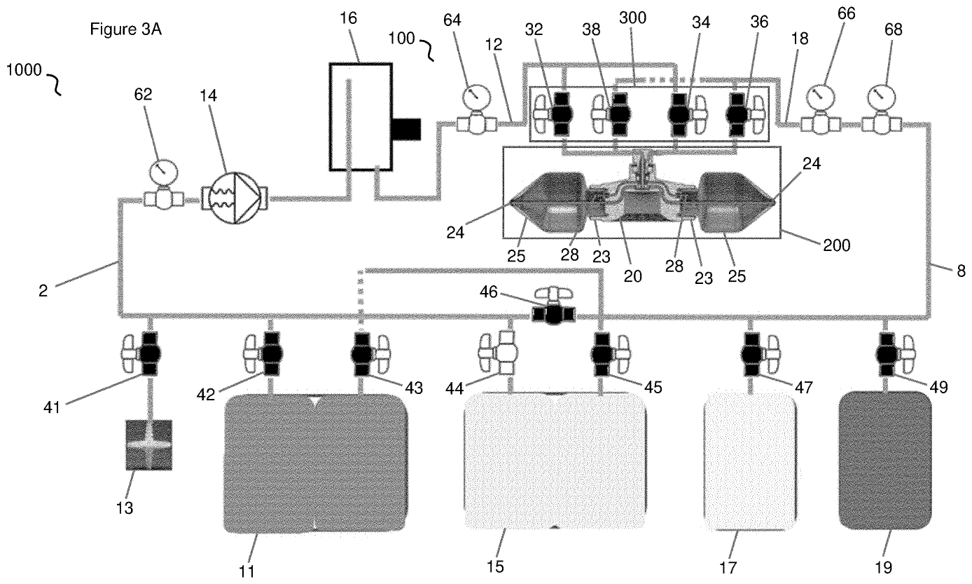

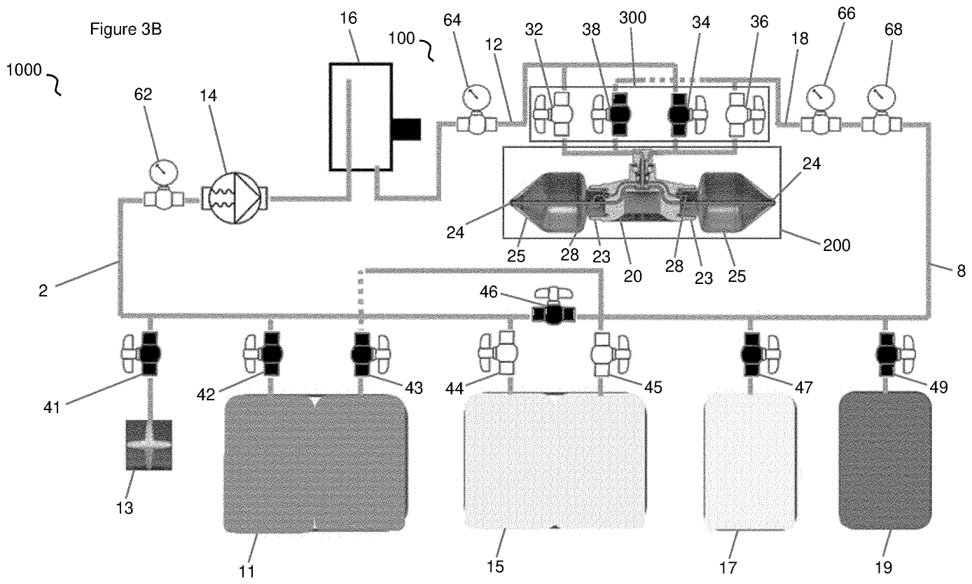

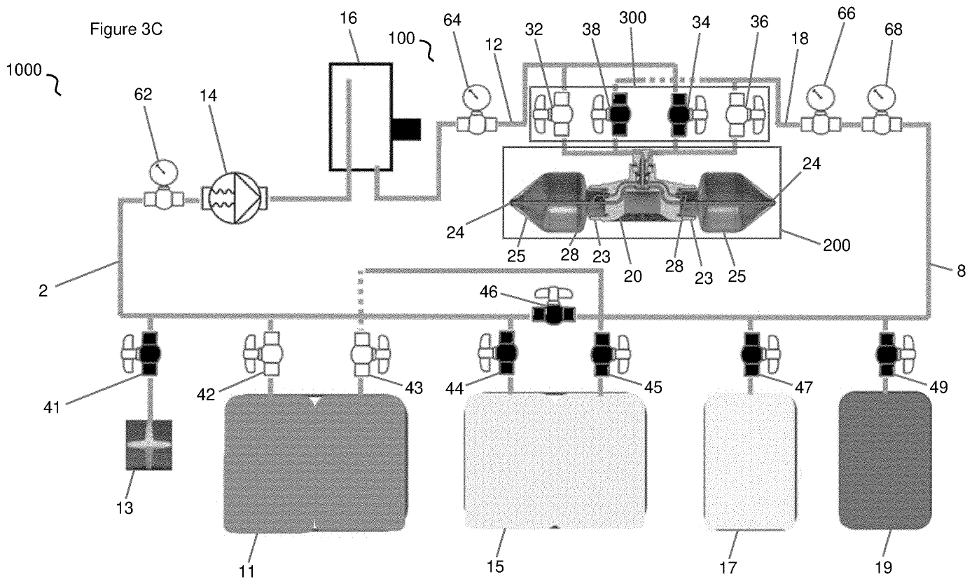

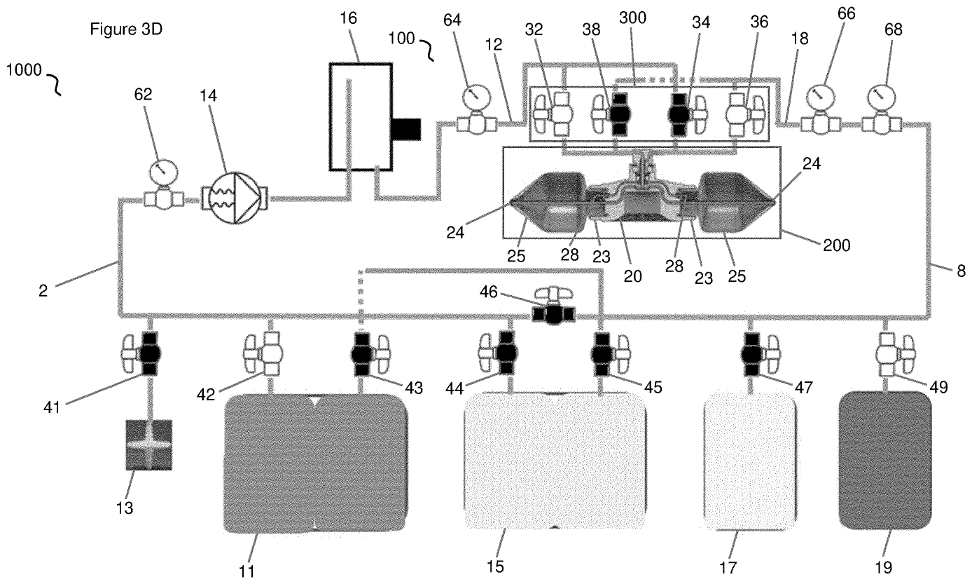

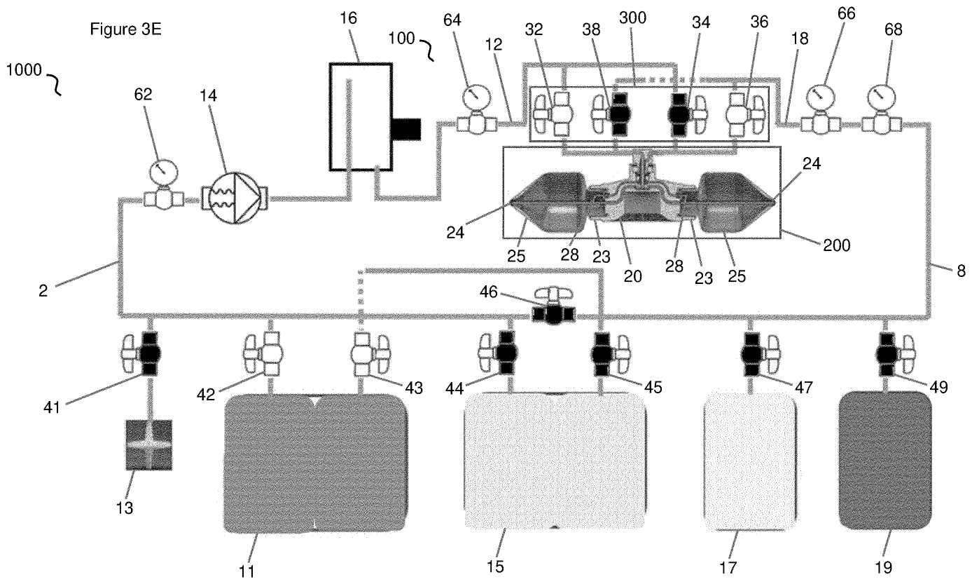

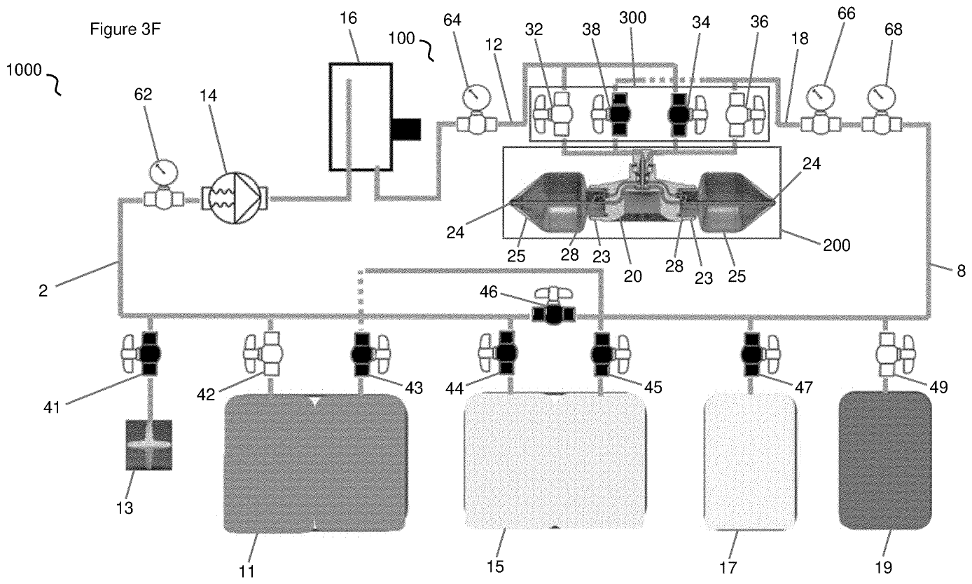

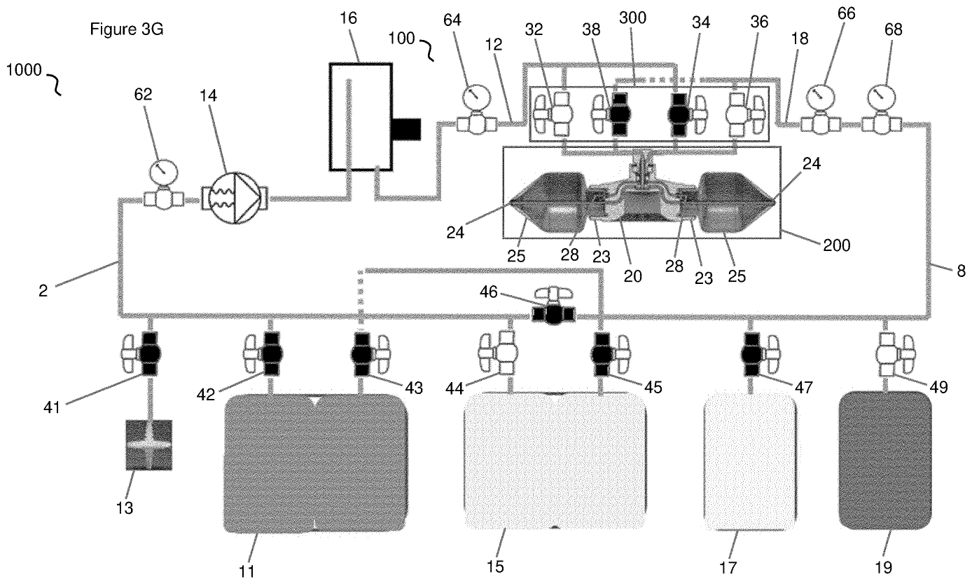

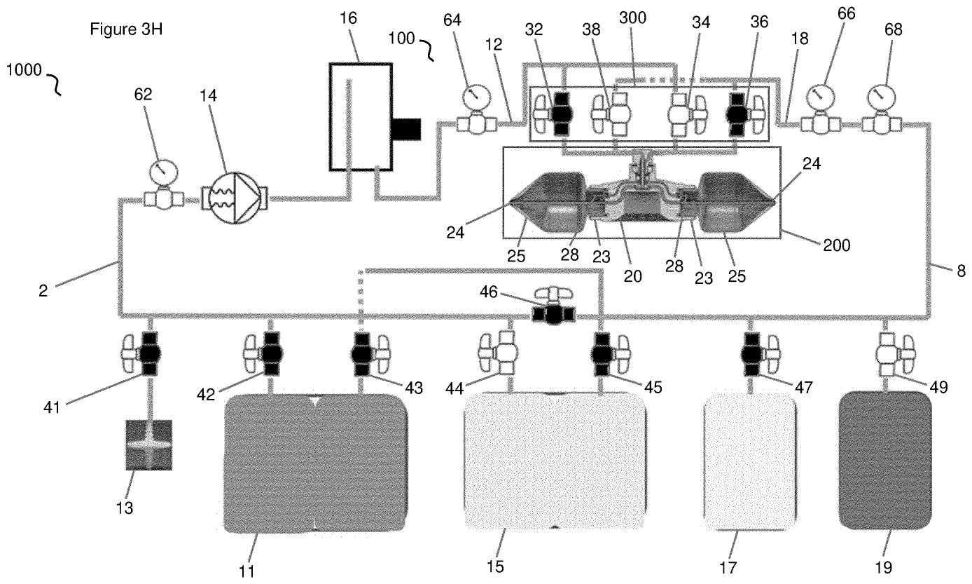

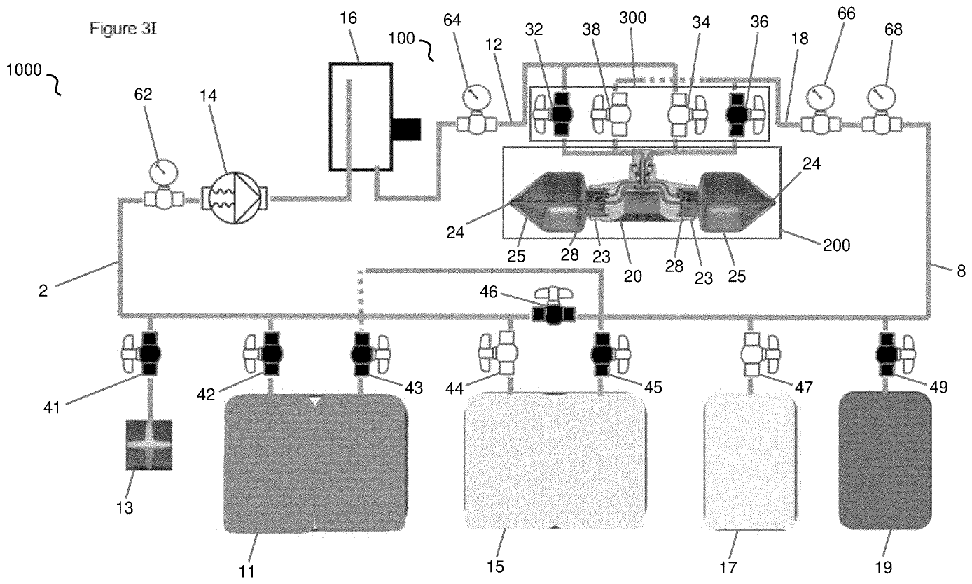

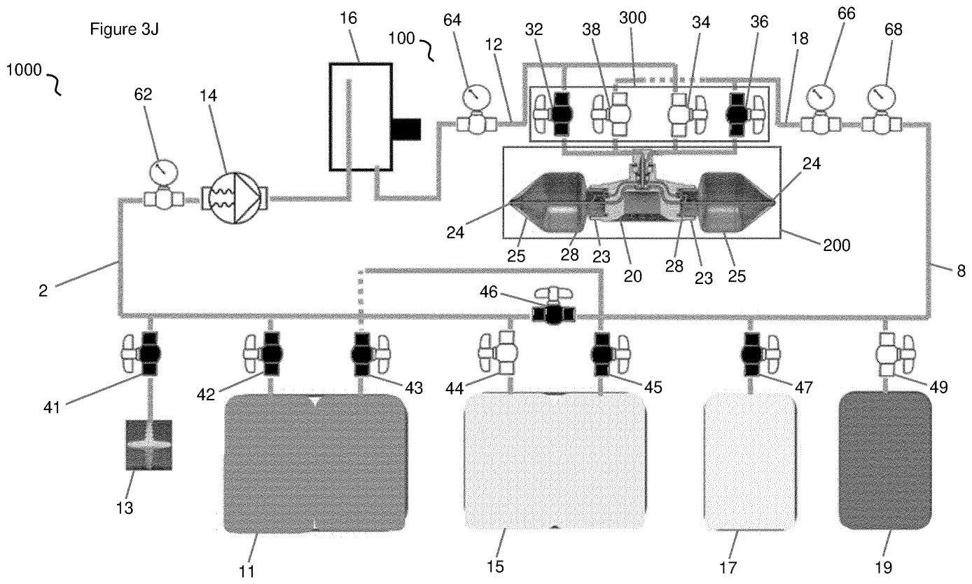

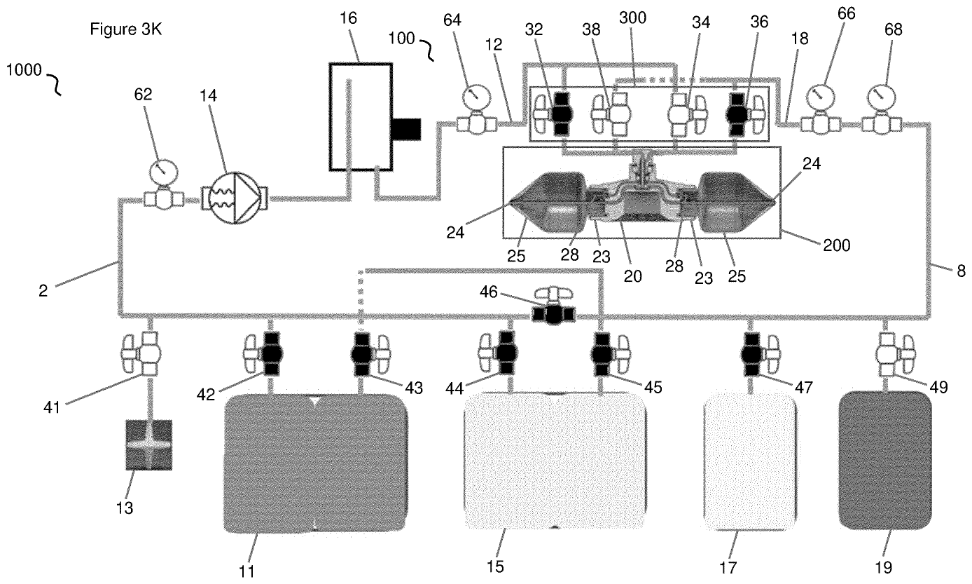

A flow loop may be defined between the outlet port 18 and the inlet port 12, which does not include the valving 300 and/or rotor 20. This flow loop can be used to recirculate fluid to the rotor 20. In certain examples, such as described with respect to FIG. 3A to 3K the flow loop may include one or more reservoirs. In any event, the pump 14 may be the only pump 14 in this flow loop. In other words, there is no other pump arranged to drive fluid in an opposite direction to the pump 14.

In this sense, the pump 14 pumps in a single direction into the inlet port 12, and the valving 300 then handles routing of the fluid.

The centrifuge assembly 100 may further comprise a cell density sensor 68, arranged downstream of the valving 300. This may be, for example, downstream of the outlet port 18. The cell density sensor 68 may be fluidically connected to the outlet port 18. By “downstream” it is meant that in the direction of a flow of fluid through the centrifuge assembly 100. In other words, fluid flowing out of valving 300 and the outlet port 18 then flows through the cell density sensor 68.

This cell density sensor 68 is configured to measure a density of cells in fluid-the prevalence of cells being carried. This can be any suitable sensor, but two common examples are capacitance sensors, optical absorbance sensors, and/or scattered light sensors. The optical absorbance sensor may be, for example, an ultraviolet (UV) absorbance sensor. Measuring the cell density may include measuring the turbidity of the fluid.

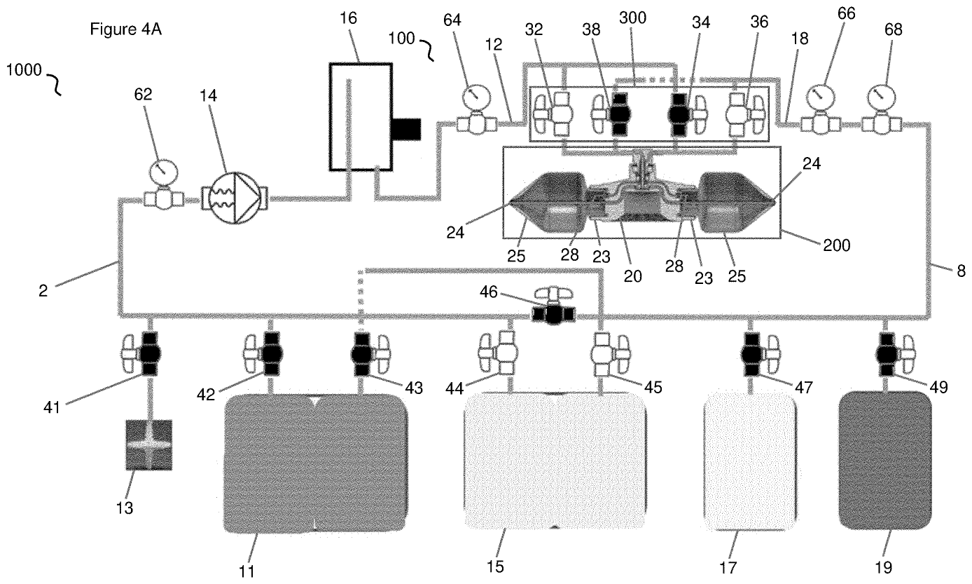

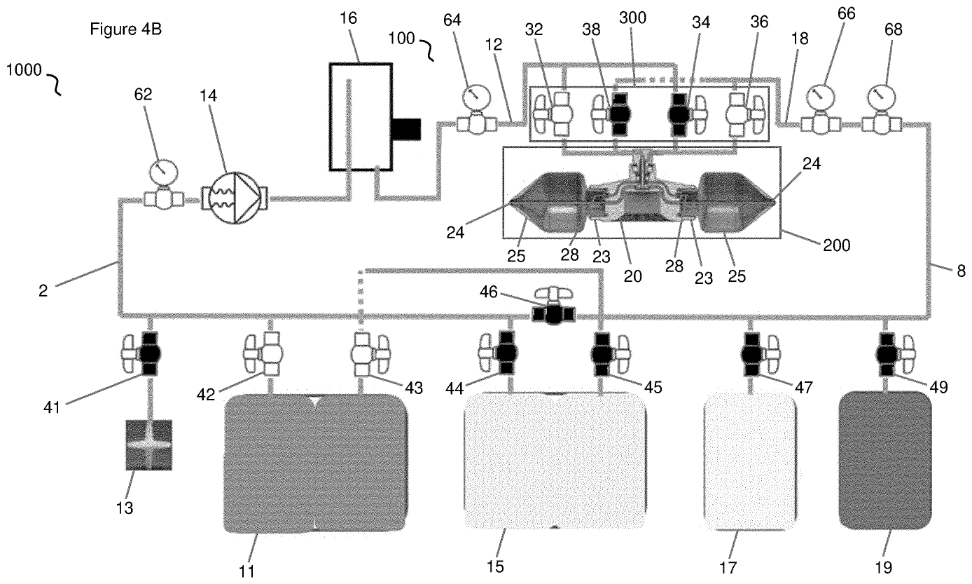

What may be particularly of importance is the density of live cells in the fluid. A capacitance sensor is able to identify only live cells, while an optical absorbance sensor detects all cells. Thus, the cell density sensor 68 may comprise both a capacitance sensor and an optical absorbance sensor, or just a capacitance sensor. Each of these arrangements is able to readily identify live cells in the fluid. Further examples are also possible with just an optical absorbance sensor, and are described below in relation to FIGS. 4A to 4B.

Again, the arrangement of the centrifuge assembly 100 means that only a single cell density sensor 68 is required as all fluid leaving the outlet port 18 flows through the cell density sensor 68. As the valving 300 handles the routing the fluid flows in the same direction around the rest of the apparatus.

Again, a flow loop may be defined between the outlet port 18 and the inlet port 12, which does not include the valving 300 and/or rotor 20. This flow loop can be used to recirculate fluid to the rotor 20. In certain examples, such as described with respect to FIG. 3A to 3K the flow loop may include one or more reservoirs. In any event, the cell density sensor 68 may be the only cell density sensor 68 in this flow loop. In other words, there is no other cell density sensor which detects cell density upstream of the inlet port 12.

The centrifuge assembly 100 may further comprise a processor. This processor may be in communication with any of the components of the centrifuge assembly 100. Particularly, the processor may be in communication with the cell density sensor 68. The processor may receive a signal from the cell density sensor 68, the signal indicative of an amount of cells in the fluid at the cell density sensor 68. The processor may then adjust one or more operating parameters of the centrifuge assembly 100 in response to this signal.

The operating parameters may be any condition of the centrifuge assembly 100 in use. This could include the valving 300 and specifically which configuration of the first configuration or second configuration (or indeed any further configurations) it is placed in. The operating parameters may further include a fluid inlet rate to the inlet port 12 (which could, for example be controlled by varying an operational speed of a pump 14). The operating parameters may further include one or more of: a rotational speed of the rotor 20; an acceleration of the rotor 20; a deceleration of the rotor 20; and/or a temperature of the centrifuge assembly 100. Each of these operating parameters may be varied as the centrifuge assembly 100 is used, and the processor can control this variation. The processor may additionally or alternatively adjust the operating parameters further based on the signal from the cell density sensor 68.

The centrifuge assembly 100 may be operated in the following method. The pump 14 is operated to pump fluid (product mixture) in a first direction. The valving 300 is in the first configuration. This means that the fluid is driven to the inlet port 12, and then the first rotor port 24 and then the second rotor port 28. From here the fluid then exits through the outlet port 18.

This may be a cell concentration stage. When the fluid contains a mixture of one or more of: live cells; dead cells; and/or culture medium this stage may capture live cells in the rotor 20, such as in container 25. Dead cells and/or culture medium may be elutriated from the rotor 20.

The valving 300 is switched from the first configuration to the second configuration.

The pump 14 continues to operate to pump fluid in the first direction. With the valving in the second configuration this means that the fluid is driven to the inlet port 12, and then the second rotor port 28 and then the first rotor port 24.

This may be a cell harvesting stage in which live cells are recovered from the rotor 20 to be harvested.

In examples with a cell density sensor 68, an output parameter of the fluid can be sensed. This output parameter may be indicative of an amount of cells in the fluid-particularly live cells. Suitable methods to detect this parameter are discussed below in relation to FIGS. 4A-4B. Operation of the centrifuge 200, valving 300 and/or pump 14 may be controlled based on the output parameter for either stage.

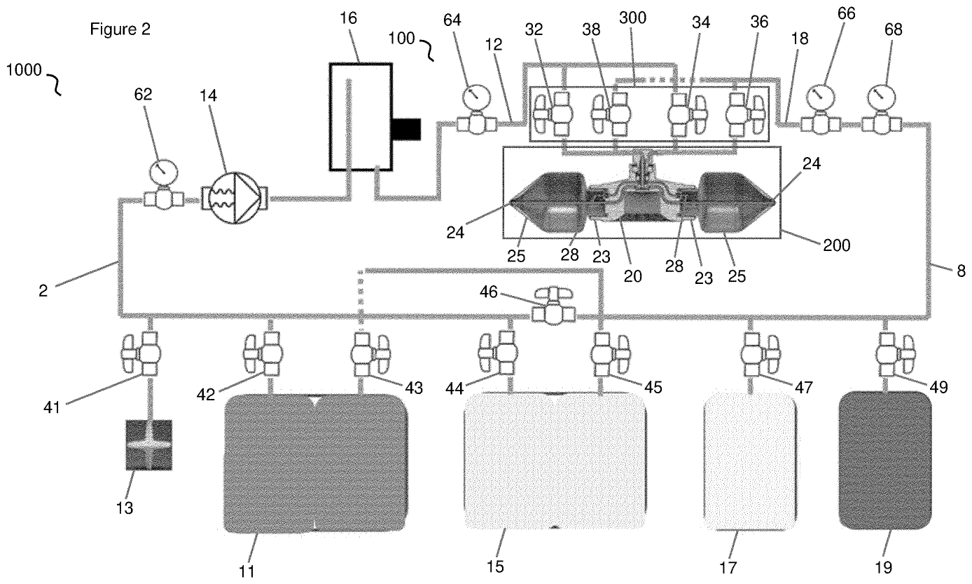

FIG. 2 shows a specific system 1000 which is set up to use the centrifuge assembly 100 of FIG. 1. Of course, any other centrifuge assembly 100 which uses valving 300 able to switch as described above may also be used. FIG. 2 does not show all of the reference numerals for the centrifuge assembly 100 given the scale of the Figure. Nevertheless, any feature or example of the centrifuge assembly 100 as described herein may be used with this system 1000.

The centrifuge assembly 100 of the system 1000 shown in FIG. 2 includes the pump 14 and cell density sensor 68. However as noted above these are not necessarily present in every example.

The system 1000 may comprise an inlet line 2 in fluid communication with the inlet port 12, upstream thereof. The system 1000 may further comprise an outlet line 8 in fluid communication with the outlet port 18, downstream thereof. The inlet line 2 and outlet line 8 may be entirely separate. In further examples such as the system 1000 of FIG. 2, the inlet line 2 and outlet line 8 may be separated by a cut-off valve 46. This cut-off valve 46 allows the inlet line 2 and outlet line 8 to be selectively isolated from one another. The pump 14 may be provided on the inlet line 2. The cell density sensor 68 may be provided on the outlet line 8.

The system 1000 may further comprise one or more reservoirs 11, 15, 17, 19. Each reservoir 11, 15, 17, 19 may have corresponding valves 42, 43, 44, 45, 47, 49 for controlling a flow of fluid into and/or out of the reservoir 11, 15, 17, 19. Each valve 42, 43, 44, 45, 47, 49 may selectively control fluid connectivity to the inlet line 2 and/or the outlet line 8. The system 1000 may include any combination of one or more of these reservoirs 11, 15, 17, 19.

A product reservoir 11 may be provided in the system 1000. The product reservoir 11 is used to supply a product to be processed by the system 1000. The product may include a mixture of one or more of live cells, culture media, and dead cells. For example, the product may include one or more of: primary T cells, NK cells, INK cells, iPSC cells, MSC cells, CHO cells, HEK293 cells, SF9 cells suspended in cell culture media. One or more product valves 42, 43 may be provided for selectively controlling a flow of fluid into and/or out of the product reservoir 11. For example, system 1000 includes a product outlet valve 42 and a product inlet valve 43. The product outlet valve 42 controls a flow of product out of the product reservoir 11, for example into the inlet line 2 of the system 1000. The product inlet valve 43 controls a flow of fluid into the product reservoir 11, for example from the outlet line 8 of the system 1000.

A buffer reservoir 15 may be provided in the system 1000. The buffer reservoir 15 is used to supply a buffer fluid to the system 1000. The buffer fluid may be, for example, phosphate buffered saline (PBS); Dulbecco's PBS (DPBS); and/or Hyaluronan synthase enzyme (HAS) supplemented PBS. One or more buffer valves 44, 45 may be provided for selectively controlling a flow of fluid into and/or out of the buffer reservoir 15. For example, system 1000 includes a buffer outlet valve 44 and a buffer inlet valve 45. The buffer outlet valve 44 controls a flow of buffer fluid out of the buffer reservoir 15, for example into the inlet line 2 of the system 1000. The buffer inlet valve 45 controls a flow of fluid into the buffer reservoir 15, for example from the outlet line 8 of the system 1000.

In certain examples, the system 1000 may comprise a plurality of buffer reservoirs 15, with each having a buffer outlet valve 44 and a buffer inlet valve 45. Each buffer reservoir 15 may comprise a different buffer solution, or the same buffer solution.

The system 1000 may comprise a harvest reservoir 17. The harvest reservoir 17 is to collect (or harvest) the treated product. A harvest valve 47 may be provided for selectively controlling a flow of fluid into the harvest reservoir 17. As the harvest reservoir 17 is for collecting the treated product it may be unnecessary to have a harvest outlet valve. The harvest valve 47 may be denoted a harvest inlet valve 47, and controls a flow of treated product into the harvest reservoir 17, for example from the outlet line 8 of the system 1000.

The system 1000 may comprise a waste reservoir 19. The waste reservoir 19 is to collect waste material from the process. A waste valve 49 may be provided for selectively controlling a flow of fluid into the waste reservoir 19. As the waste reservoir 19 is for collecting the waste material it may be unnecessary to have a waste outlet valve. The waste valve 49 may be denoted a waste inlet valve 49, and controls a flow of waste material into the waste reservoir 19, for example from the outlet line 8 of the system 1000.

In certain examples, the waste reservoir 19 and harvest reservoir 17 may be reversed depending on the desired product of the system 1000. That is, the material collected in waste reservoir 19 when the method discussed herein is performed may be the desired product of the system 1000.

The system 1000 may comprise an air inlet 13. The air inlet 13 may be, for example, an air pump or simply a connection to an external source of air such as an open air port. The air inlet 13 inlets air into the system 1000. This may be into the inlet line 2. This air inlet 13 may comprise a filter element to filter any air being inlet into the system 1000. This may specifically be a sterile filter. An air valve 41 may be provided between the air inlet 13 and the system 1000 to selectively control inlet of air into the system 1000.

As noted above, any combination of these reservoirs 11, 15, 17, 19 and/or air inlet 13 is contemplated and may be used for the system 1000 as appropriate.

A bubble trap 16 may also be provided in the system 1000. This bubble trap 16 may be provided in the inlet line 2. For example, the bubble trap 16 may be provided in the inlet line 2. Specifically the bubble trap 16 may be downstream of the pump 14 and upstream of the first inlet 12 and/or valving 300. That is, the bubble trap 16 may be between the pump 14 and the first inlet 12 and/or valving 300. The bubble trap 16 acts to remove any bubbles from fluid being moved around the system 1000. In certain examples the bubble trap 16 may vent to an external area. This could be controlled by a bubble valve (not shown). Vented bubbles may pass through a filter (also not shown). In certain examples, the bubble trap 16 may be provided immediately before the first rotor port 24.

The cell density sensor 68 is already discussed above. The system 1000 may comprise, in addition or alternatively, one or more further sensors. Again any combination of sensors is contemplated for the system 1000. Any of the provided sensors may be in communication with the processor of the centrifuge assembly 100. The processor may control the operating parameters of the centrifuge assembly 100 based on sensed data from any of the provided sensors.

For example, the system 1000 may comprise an air/liquid detector 62. The air/liquid detector 62 may be in the inlet line 2 of the system 1000. This could be located, for example, upstream of the pump 14. In certain examples the air/liquid detector 62 may be downstream of the air inlet 13. That is the air/liquid detector 62 may be between the air inlet 13 and pump 14. The air/liquid detector 62 is configured to determine that fluid is flowing through the system 1000, and whether there are air bubbles in said fluid.

A pressure sensor 64 may be provided in the system 1000. The pressure sensor 64 senses a pressure of fluid flowing in the system. The pressure sensor 64 may be in the inlet line 2 of the system. For example, the pressure sensor 64 may be downstream of the pump 14. In examples with a bubble trap 16, the pressure sensor 64 may be downstream of the bubble trap 16. The pressure sensor 64 may be upstream of the inlet port 12 and/or valving 300. In other words, the pressure sensor 64 may be between the pump 14 (and bubble trap 16) and the inlet port 12/valving 300.

A flow sensor 66 may be provided in the system 1000. The flow sensor 66 measures a parameter of fluid flow through the system 1000. For example, this may include one or more of: a flow velocity, flow rate (volumetric or mass), temperature, or any other parameter of the flow. The flow sensor 66 may be in the outlet line 8. The flow sensor 66 may be arranged, for example, downstream of the outlet port 18. In certain examples, the flow sensor 66 may be between the outlet port 18 and the cell density sensor 68. However this is not the only arrangement and the flow sensor 66 may be provided at any suitable location in the system 1000.

In certain examples, a first and second flow sensors 66 may be provided, one either side of the centrifuge assembly 100. Readings from each flow sensor 66 can then be compared in order to identify any blockages and/or leakages in the centrifuge assembly 100.

This system 1000 can be operated such that fluid is driven into the centrifuge assembly 100, such as by constant forward operation of the pump 14. The valving 300 then operates to route the fluid flow between a counter-flow regime and an in-flow regime. Thus the system 1000 can be used for complex processing.

A particular operation of the system 1000 (known as cell harvest) is described with reference to FIGS. 3A to 3K. The depicted system 1000 is generally as shown in FIG. 2. However any modifications discussed above may be incorporated into the system 1000 as appropriate. In these Figures, each valve 32, 34, 36, 38, 41, 42, 43, 44, 45, 46, 47, 49 is shown with a white filling when it is open and allows fluid flow therethrough, and with a black filling when it is closed and inhibits and/or prevents fluid flow therethrough. The schematic handles are always shown with a white filling. Unless otherwise specifically referenced, each valve 32, 34, 36, 38, 41, 42, 43, 44, 45, 46, 47, 49 should be considered to be in the closed position.

This operation may be particularly suitable for the separation of live cells from dead cells and culture media. For example, for culture meat and cargocyte. It may not be necessary to include every step and configuration shown in these Figures.

FIG. 3A shows the system in a first priming step. This is particularly for priming the bubble trap 16. All of the valves 32, 34, 36, 38, 41, 42, 43, 44, 45, 46, 47, 49 are closed, except for the buffer outlet valve 44 which is open. The pump 14 may be operated in this step. Buffer fluid may therefore flow from the buffer reservoir 15 into the inlet line 2, and ultimately the bubble trap 16. In this step, air is pushed out of the bubble trap 16. The first priming step may be performed for a set amount of time during which the bubble trap 16 is expected to be primed.

Alternatively, or additionally, one or more of the sensors 62, 64, 66, 68 may be used in the first priming step. For example, the air/liquid detector 62 may be used to determine that the buffer fluid is flowing into the bubble trap 16. It may also, or alternatively, be possible to measure a fill level of the bubble trap 16. Once it is determined that the bubble trap 16 is filled, the first priming step may be considered complete. The system 200 may use a combination of expected timing and sensed parameters to determine a length of the first priming step.

An alternative first priming step may be performed, in which the bubble trap 16 is primed by aspiration. For such an alternative first priming step, the second valve 34, fourth valve 38, buffer outlet valve 44 and buffer inlet valve 45 may be open. The pump 14 is ran in an opposite direction to that shown in FIG. 3A. Again, this alternative first priming step may be performed for a set amount of time during which the bubble trap 16 is expected to be primed, and/or one or more of the sensors 62, 64, 66, 68 may be used in the alternative first priming step.

A second priming step is shown in FIG. 3B. While denoted a “second” priming step, it is anticipated that this may be performed before and/or simultaneously with the first priming step, or in an operation which omits the first priming step in its entirety. In this second priming step, the buffer outlet valve 44 and the buffer inlet valve 45 are open.

The valving 300 is in the first configuration. For example, this may mean that the first valve 32 is open and the second valve 34 is closed. This means that fluid flowing into the inlet port 12 is directed to the first rotor port 24. The third valve 36 is open and the fourth valve 38 is closed. This means that fluid flows into the second rotor port 28 and then out of the outlet port 18. This may be the counter-flow regime.

This second priming step may be used to load buffer into the system 200. The pump 14 may be operated to draw buffer solution from the buffer reservoir 15. This is then driven through the valving 300, the centrifuge 200 and back to the buffer reservoir 15.

When the air/liquid detector 62 and/or the flow sensor 66 indicate that the buffer solution is the only fluid moving around the system 1000, the centrifuge 200 may be operated. Specifically, the rotor 20 may be spun at a first centrifuge speed. An example first centrifuge speed may be in the region of 250 to 350 rotations per minute (rpm), such as 300 rpm. The pump 14 may be set to a slow flow rate.

In this step buffer fluid is pumped around the system to remove any air from the centrifuge 200 and/or valving 300. Once the air/liquid detector 62 and/or the flow sensor 66 indicate that the buffer solution is the only fluid moving around the system 1000, the valving 300 may be switched to the second configuration. For example, the first valve 32 may be closed and the second valve 34 may be open This means that fluid flowing into the inlet port 12 is directed to the second rotor port 28. The third valve 36 may be closed and the fourth valve 38 may be open, This means that fluid flows into the first rotor port 24 and then out of the outlet port 18. This may be the in-flow regime. This allows the other fluid passageways of the system 1000 to be cleared of air. This arrangement is not shown in the order of Figures as it is only temporary to clear the fluid passageways.

Once the air/liquid detector 62 and/or the flow sensor 66 indicate that the buffer solution is the only fluid moving around the system 1000, the valving 300 may be switched back to the first configuration. For example, this may mean that the first valve 32 is open and the second valve 34 is closed. This means that fluid flowing into the inlet port 12 is directed to the first rotor port 24. The third valve 36 is open and the fourth valve 38 is closed. This means that fluid flows into the second rotor port 28 and then out of the outlet port 18. This may be the counter-flow regime.

The operation is then continued back in this configuration (FIG. 3B) until there is a stable reading from the air/liquid detector 62 and/or flow sensor 66 and/or pump 14 speed.

A step of resetting the sensors 62, 64, 66, 68 may then be performed. Fluid flow through the system 1000 may be stopped, such as by stopping the pump 14. Once there is a stable reading from the pressure sensor 64 and/or the flow sensor 66 all of the valves 32, 34, 36, 38, 41, 42, 43, 44, 45, 46, 47, 49 may be closed. The system is then left for a predetermined wait period. After this predetermined wait period, the sensors 62, 64, 66, 68 are reset (e.g. tared to a zero value). The system is then left for a further predetermined wait period, which may be the same or different to the earlier predetermined wait period.

After this further predetermined wait period, the system 1000 is returned to the state shown in FIG. 3B. The buffer outlet valve 44 and the buffer inlet valve 45 are open. The valving 300 is in the first configuration. For example, this may mean that the first valve 32 is open and the second valve 34 is closed. This means that fluid flowing into the inlet port 12 is directed to the first rotor port 24. The third valve 36 is open and the fourth valve 38 is closed. This means that fluid flows into the second rotor port 28 and then out of the outlet port 18. This may be the counter-flow regime. Fluid is again driven through the system 1000, such as using the pump 14. The pump 14 may be set to the same slow flow rate as previously.

From this state, the rotational speed of the rotor 20 is increased until it reaches a target rotational speed. Once the rotor 20 has reached the target speed and the flow rate has reached a target flow rate the system 1000 is ready to process the product.

As shown in FIG. 3C, the buffer outlet valve 44 and buffer inlet valve 45 are closed. The product outlet valve 42 is open, and the product inlet valve 44 is open. The valving 300 is in the first configuration.

In this state, a product bed is formed about the system 1000. Product mixture is driven from the product reservoir 11, along the inlet line, into the inlet port 12, through the valving 300, through the centrifuge 200, back through the valving 300, through the outlet port 18, along the outlet line 8 and back to the product reservoir 15. As noted above, the centrifuge 200 may be in the counter-flow regime. The sensed flow parameters from the flow sensor 66 may be observed to watch for stable flow of product mixture through the system 1000.

As the product mixture passes through the centrifuge 200, cells in the mixture are driven outwardly in the container 25 and retained therein while culture media passes through the system 1000. Particularly, live cells may be driven outwardly in the container and retained therein.

Once the bed has been formed, the cells may be concentrated such as shown in FIG. 3D. The product inlet valve 43 is closed. The product outlet valve 42 is open. The waste valve 49 is open. The valving 300 is in the first configuration. In this state, culture media which exits the centrifuge 200 is delivered to the waste reservoir 19 while cells (particularly live cells) are retained, thereby increasing the cell concentration.

The flow sensor 66 and/or cell density sensor 68 may indicate that the bed has become unstable. In which case, the system 1000 may be switched to the configuration of FIG. 3E. The waste valve 49 is closed. The product outlet valve 42 is open, and the product inlet valve 44 is open. The valving 300 is in the first configuration. This is generally the same as the configuration of FIG. 3C. This allows the bed to re-form. This may be performed with a lower fluid flow rate, for example by reducing a speed of the pump 14.

The system is then switched back to a cell concentration configuration, such as shown in FIG. 3F. If the fluid flow rate had been reduced, then it may be increased back up again. This is generally the same as shown in FIG. 3D. The product inlet valve 43 is closed. The product outlet valve 42 is open. The waste valve 49 is open. The valving 300 is in the first configuration. In this state, culture media which exits the centrifuge 200 is delivered to the waste reservoir 19 while cells (particularly live cells) are retained, thereby increasing the cell concentration.

In either of the cell concentration steps, the signal from the air/liquid detector 62 is monitored. If this indicates that air is being detected then this means that the product reservoir 11 is empty. This means that the concentration step has been completed.

Following cell concentration, the cells are to be washed as shown in FIG. 3G. The product outlet valve 42 is closed. The buffer outlet valve 44 is open. The waste valve 49 is open. The valving 300 is in the first configuration. In this configuration, more buffer fluid is driven around the system 1000. This buffer fluid driven around the system 1000 helps to remove more dead cells and culture media from the container 25.

After a period, the cell washing step is finished. This period can be defined based on sensed values of the flow and/or based on a set time period. If, during the washing step, live cells are detected by the cell density sensor 68 the cell concentration step can be repeated and/or properties of the flow adjusted to compress the live cells in the container 25. Once washing is finished, the system 1000 is prepared for the recovery of the live cells. The first step of this recovery is to change the flow through the centrifuge to an in-flow regime from the counter-flow regime. To achieve this, the valving 300 is switched to the second configuration as shown in FIG. 3H. For example, the first valve 32 may be closed and the second valve 34 may be open This means that fluid flowing into the inlet port 12 is directed to the second rotor port 28. The third valve 36 may be closed and the fourth valve 38 may be open, This means that fluid flows into the first rotor port 24 and then out of the outlet port 18. The buffer outlet valve 44 is open. The waste valve 49 is open.

In this state, the speed of the rotor 20 may be reduced. If the flow sensor 66 and/or cell density sensor 68 indicates that turbidity of the fluid is increasing then the waste valve 49 may be closed.

After this preparation step, recovery of the cells may be performed as shown in FIG. 3I. The waste valve 49 is closed. The harvest valve 47 is open. The buffer outlet valve 44 is open. The valving 300 is in the second configuration.

In this state, flow of buffer through the centrifuge will entrain and drive the collected cells out of the container 25 and hence through the outlet port 18, outlet line 8 and into the harvest reservoir 17.

Once the cells have been harvested, the system 1000 is prepared to be flushed (FIG. 3J). The harvest valve 47 is closed. The waste valve 49 is open. The buffer outlet valve 44 is open. The valving 300 is in the second configuration. Buffer fluid is driven through the centrifuge 200 to flush out the system 1000. The rotational speed of the rotor 20 may be further decreased in this state.

To complete the flushing, the system 1000 may be moved to the configuration shown in FIG. 3K. The air valve 41 is opened to allow air from the air inlet 13 into the system 1000. The waste valve 49 is open. The valving 300 is in the second configuration.

The flow rate of fluid through the system may be increased, for example by increasing a speed of the pump 14. The system 1000 is operated in this state until the air/liquid detector 62 and/or the flow sensor 66 indicate that a sufficient amount of air is in the system 1000.

Once this flushing is complete, the centrifuge 200 is stopped. The pump 14 is stopped. All of the valves 32, 34, 36, 38, 41, 42, 43, 44, 45, 46, 47, 49 are closed. The operation is then complete. The user can remove/empty the harvest reservoir 17. Once this is complete, the valves 32, 34, 36, 38, 41, 42, 43, 44, 45, 46, 47, 49 may be opened.

In this sense, the system 1000 incorporating the centrifuge assembly 100 can be used to separate cells, particularly live cells. The system 1000 does not require fluid flow to be reversed, such as by reversing pump 14, thanks to the valving 300.

As noted above, the cell density sensor 68 may comprise both a capacitance sensor and an optical absorbance sensor, or just a capacitance sensor. Each of these arrangements is able to readily identify live cells in the fluid. Further examples are also possible with just an optical absorbance sensor. However, for these further examples additional calibration of the system 1000 may be required. Such a calibration is described with reference to FIGS. 4A and 4B.

The system 1000 shown in FIGS. 4A and 4B is generally as described herein and may include any of the modifications discussed as appropriate. The cell density sensor 68 is an optical absorbance sensor. For example, the cell density sensor 68 may be an ultraviolet (UV) absorbance sensor. With such a cell density sensor 68 it is not possible to tell the difference between live cells and dead cells. To counter this, the following calibration may be performed.

The system 1000 is set up as shown in FIG. 4A. The buffer outlet valve 44 and buffer inlet valve 45 are open. The valving 300 is in the first configuration. For example, this may mean that the first valve 32 is open and the second valve 34 is closed. This means that fluid flowing into the inlet port 12 is directed to the first rotor port 24. The third valve 36 is open and the fourth valve 38 is closed. This means that fluid flows into the second rotor port 28 and then out of the outlet port 18. This may be the counter-flow regime.

In this state, buffer fluid may be driven around the system 1000, such as by pump 14. The centrifuge 200 may be inactive at this point. The cell density sensor 68 reading for this state is recorded as a base-level absorbance. This base-level absorbance may be used later to confirm that flushing of the system 1000 is complete.

The system 1000 is then switched to the set-up of FIG. 4B. The buffer outlet valve 44 and buffer inlet valve 45 are closed. The product outlet valve 42 and product inlet valve 43 are open. The valving 300 is in the first configuration.

Product mixture is then driven around the system 1000. This product mixture includes at least live cells and dead cells. A first pump speed and first centrifuge speed are set such that live cells will be captured in the container 25, while dead cells will be elutriated. These speeds may be set, for example, by a user inputting cell culture characteristic data which is used to select an appropriate first pump speed and second pump speed. This may be, for example, live cells size, cell viability, and/or cell concentration. As the system 1000 is operated, live cells are therefore retained in container 25 while dead cells flush past the cell density sensor 68. A first optical absorbance is measured by the cell density sensor 68. This first optical absorbance represents the value when only dead cells are passing the cell density sensor 68.

Then, a background noise is defined based on this first optical absorbance. In certain examples, the background noise may be equal to the first optical absorbance. In further examples there may be additional processing involved to convert the first optical absorbance to the background noise value. This background noise value is stored, for example on the processor or on a storage medium.

The system 1000 may then be operated as disclosed herein. During the cell recovery (FIGS. 3H & 3I), the valving 300 is switched to the second configuration and the live cells are removed from the container 25 through the outlet port 18. An optical absorbance of the harvested cells is measured, and the background noise value is subtracted from the optical absorbance in order to determine an amount of live cells in the recovered fluid.

In this sense, an optical absorbance sensor can be used alone as the cell density sensor 68.

While this is the simplest calibration of the optical absorbance sensor, there may be additional calibration steps.

For example, after the first optical absorbance is measured, the flow rate of fluid through the system 1000 may be increased. The centrifuge rotational speed may be corresponding decreased. At a certain point, live cells will stop being retained in the container 25 and be elutriated out of the container 25 with the dead cells. This means that the optical absorbance detected by the cell density sensor 68 will change. The background noise may be compared to a second optical absorbance value which was taken immediately before this change as immediately before the change there should only be dead cells being elutriated. In certain examples, the background noise may be an average of the first optical absorbance value and the second optical absorbance value.

Performing this additional step may also be useful for determining operating conditions for the system 1000 as the boundary parameters which result in live cells being undesirable elutriated are now known. In the cell concentration stage (FIG. 3F) the system 1000 may be operated below these boundary parameters to ensure that all live cells are retained in the container 25 while dead cells are elutriated.

In this sense, the centrifuge assembly 100 can be calibrated for the use of an optical absorbance sensor.

While various rotors 20 have been described herein which take advantage of using multiple container mountings 23 it has been noted that conventional containers 25 may perform sub-optimally with these rotors 20, particularly when a single feed pump 14 is used.

The rotor 20 may still use conventional containers 25 but performance of the system may be inhibited. FIGS. 1 to 4B show such a rotor 20 with conventional containers 25 attached. This conventional container 25 may, however, perform sub-optimally for arrangements with multiple containers 25 being delivered with fluid from a single feed pump 14.

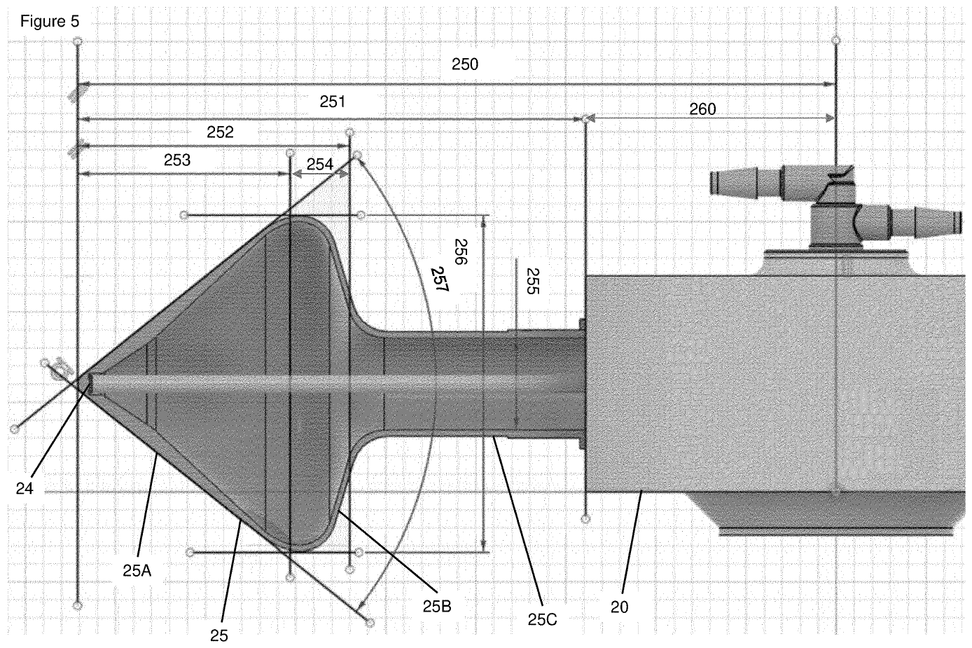

FIG. 5 shows an improved container 25 for such inserts 20a, in an isolated partial cross-sectional view of a rotor 20 and improved container 25. The cross-section of FIG. 5 is partial as only the container 25 is shown in cross-section, while the rotor 20 is not.

The container 25 comprises an elongate stem 25C and a head portion. The head portion is at a second end of the elongate stem 25C. A first end of the elongate stem 25C (opposite the second end) comprises an attachment portion of the container 25. The attachment portion is for attaching to a rotor 20 (either directly or via a rotor insert). The head portion may be any suitable shape, but in general radially extends outwardly from the elongate stem 25C and then tapers to an apex away from the elongate stem 25C. In the example of FIG. 5 the head comprises a first conical shape 25A and a second conical shape 25B. Such a head may be described as generally conical. A base of each conical shape 25A, 25B has a diameter greater than a diameter of the elongate stem 25C. In certain arrangements, there may be no second conical shape 25B, and the elongate stem 25C may directly contact a base of the first conical shape 25A.

The stem 25C is elongate in that it is longer than it is wide (i.e. its diameter). The container 25 may have a container length and the elongate stem 25C may extend at least 40% of the container length. The elongate stem 25C may have a greater length than the head, for example than the first conical shape 25A. In other words, the container 25 may have a container length and the elongate stem 25C may extend at least 50% of the container length. In this sense, the elongate stem 25C is much longer than the attachment portion of the conventional container of FIGS. 1 to 4B. For example, the elongate stem 25C may have a length of at least 5 centimetres.

This container 25 may be particularly useful in systems which have a single pump 14. Conventional systems will have a separate feed pump for each container. However, with a single pump 14 distribution of fluid flow into each container 25 may become unstable. The design of the improved containers 25 allows for stable flow even when a single pump 14 is used to supply fluid to all of the containers 25. This may be, for example, via any of the fluid passageways described herein.

FIG. 5 shows a particular container 25 which has been found to be particularly effective in such an arrangement.

The container 25 comprises an elongate stem 25C and a head portion. The head portion is at a second end of the elongate stem 25C. A first end of the elongate stem 25C (opposite the second end) comprises an attachment portion of the container 25. The attachment portion is for attaching to a rotor 20 (either directly or via a rotor insert). The head portion of the container 25 in FIG. 5 comprises a first conical shape 25A and a second conical shape 25B. Such a head may be described as generally conical. A base of each conical shape 25A, 25B has a diameter greater than a diameter of the elongate stem 25C.

The head portion of the container 25 has a head length 252. This head length 252 may be between 40% to 60% of a total length of the container 25. In certain examples the head length 252 may be between 70 millimetres and 80 millimetres.

This head length 252 may be made up of a first conical length 253 corresponding to the length of the first conical shape 25A, and a second conical length 254 corresponding to the length of the second conical shape 25B. As noted above, the second conical length 254 may be zero (i.e. there is no second conical shape 25B) in certain examples.

In general, the first conical length 253 may be much greater than the second conical length 254. For example, the first conical length 253 may be 70% or greater of the head length 252. Additionally, or alternatively, the first conical length 253 may be less than 85% of the head length 252. The first conical length 253 may be in the region of 50 millimetres to 70 millimetres, for example between 55 millimetres and 60 millimetres.

The rest of the head length 252 is made up of the second conical length 254. This second conical length 254 may be up to 30% of the head length 252. Additionally, or alternatively, the second conical length 254 may be 15% or more of the head length 252. The second conical length 254 may be in the region of 10 millimetres to 20 millimetres.

The first conical shape 25A may have a cone angle 257. This cone angle 257 may be formed as a vertex angle made by a cross section through the apex of the first conical shape 25A and a centre of the base of the first conical shape 25A. The cone angle 257 may be between 70° and 85°, for example between 75° and 80°.

A base of the first conical shape 25A has a base width 256. This base width 256 may be between 150% and 160% of the first conical length 253. In certain examples, the base width 256 may be in region of 90 millimetres to 100 millimetres.

The elongate stem 25C of the container 25 has a stem length and a stem diameter 255. The stem diameter 255 may be an inner diameter of the elongate stem 25C as this is the relevant diameter for the flow of fluid from the container 25. The stem diameter 255 may be in the region of 20% to 30% of the base width 256. In certain examples, the stem diameter 255 may be in the region of 20 millimetres to 30 millimetres.

FIG. 5 shows this container 25 attached to a rotor 20. In this attached position, a radial extent 250 of the container 25 is defined. This is a measure from a centre of the rotor 20 (or indeed rotor insert) to an outermost point of the container 25. The rotor 20 itself has a rotor diameter 260 from the centre of the rotor 20 to an outermost part of the rotor 20. This rotor diameter 260 may be in the region of 65 millimetres to 75 millimetres. The radial extent 250 of the container 25 may be defined with respect to this rotor diameter 260. For example, the radial extent 250 may be between 290% and 310% of the rotor diameter 260. In certain examples, the radial extent may be in the region of 200 millimetres to 220 millimetres. For example, between 205 and 215 millimetres. This leaves an exposed radius 251 of the container 25. This is the amount of the container 25 which is not inserted into the rotor 20. The exposed radius 251 can be defined as the radial extent 250 with the rotor diameter 250 subtracted therefrom. The portion of the container 25 inserted into the rotor inset 20a may be defined an attachment portion of the container 25, such as a threaded section.

In this sense, a container 25 is provided which may be particularly beneficial for multi-container processing.

It will be appreciated that embodiments of the disclosure may be implemented using a variety of different information processing systems. In particular, although the Figures and the discussion thereof provide exemplary computing systems and methods, these are presented merely to provide a useful reference in discussing various aspects of the disclosure. Embodiments may be carried out on any suitable data processing device, such as a personal computer, laptop, tablet, personal digital assistant, mobile telephone, smart phone, set top box, television, server computer, etc. Of course, the description of the systems and methods has been simplified for purposes of discussion, and they are just one of many different types of systems and methods that may be used. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules. Moreover, multiple method steps implemented in flowcharts contained herein, or as described above, may be implemented together by a single module.

It will be appreciated that, insofar as embodiments of the disclosure are implemented by a computer program, then a storage medium and a transmission medium carrying the computer program form aspects of the disclosure. The computer program may have one or more program instructions, or program code, that, when executed by a computer, causes an embodiment of the disclosure to be carried out. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a Blu-ray disc), or a memory (such as a ROM, a RAM, EEPROM, EPROM, Flash memory or a portable/removable memory device), etc. The transmission medium may be a communications signal, a data broadcast, a communications link between two or more computers, etc.

Each feature disclosed in this specification, unless stated otherwise, may be replaced by alternative features serving the same, equivalent, or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as a component or an element) means “one or more” (for instance, one or more components, or one or more elements). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

A method of manufacturing and/or operating any of the devices disclosed herein is also provided. The method may comprise steps of providing each of the features disclosed and/or configuring or using the respective feature for its stated function.

### Clauses

1. A centrifuge assembly comprising:
a rotor, rotationally mounted about an axis of rotation, the rotor comprising a first rotor port and a second rotor port, the second rotor port radially spaced from the first rotor port with respect to the axis of rotation;
an inlet port and an outlet port; and
valving configured to selectively fluidically connect:
   the inlet port with the first rotor port and the outlet port with the second rotor port in a first configuration of the valving; or
   the inlet port with the second rotor port and the outlet port with the first rotor port in a second configuration of the valving.

2. The centrifuge assembly of clause 1, further comprising a pump fluidically connected to the inlet port upstream of the valving, the pump for driving fluid through the rotor.

3. The centrifuge assembly of clause 2, wherein the pump is configured to only drive fluid in a single direction in a mode of operation.

4. The centrifuge assembly of clause 2 or 3, wherein the pump is the only pump in a flow loop defined between the outlet port and the inlet port.

5. The centrifuge assembly of any preceding clause, further comprising a cell density sensor fluidically connected to the outlet port downstream of the valving.

6. The centrifuge assembly of clause 5, wherein the cell density sensor comprises one or more of:
a capacitance sensor;
an optical absorbance sensor; and/or
a scattered light sensor.

7. The centrifuge assembly of clause 5 or 6, wherein the cell density sensor is the only cell density sensor in a flow loop defined between the outlet port and the inlet port.

8. The centrifuge assembly of any of clauses 5 to 7, further comprising:
a processor in communication with the cell density sensor to receive a signal, the processor configured to adjust one or more operating parameters of the centrifuge assembly in response to the signal.

9. The centrifuge assembly of clause 7, wherein the operating parameters comprise:
a rotational speed of the rotor;
an acceleration of the rotor;
a deceleration of the rotor;
a temperature of the centrifuge assembly;
a fluid inlet rate to the inlet port; and/or
the configuration of the valving.

10. The centrifuge assembly of any preceding clause, wherein the valving comprises:
first valving for selectively fluidically connecting the inlet port with the first rotor port or the second rotor port; and
second valving for selectively fluidically connecting the outlet port with the second rotor port or the first rotor port.

11. The centrifuge assembly of clause 10, wherein:
the first valving comprises:
   a first valve between the inlet port and the first rotor port; and
   a second valve between the inlet port and the second rotor port;
the second valving comprises:
   a third valve between the outlet port and the second rotor port; and
   a fourth valve between the outlet port and the first rotor port,
      preferably wherein:
in the first configuration the first valve is open, the second valve is closed, the third valve is open and the fourth valve is closed; and
in the second configuration the first valve is closed, the second valve is open, the third valve is closed and the fourth valve is open.

12. The centrifuge assembly of any preceding clause, wherein the rotor comprises a plurality of first rotor ports and second rotor ports, each second rotor port radially spaced from the corresponding first rotor port with respect to the axis of rotation.

13. The centrifuge assembly of clause 12, wherein the valving is configured to selectively fluidically connect:
the inlet port with each first rotor port and the outlet port with each second rotor port in the first configuration of the valving; or
the inlet port with each second rotor port and the outlet port with each first rotor port in the second configuration of the valving.

14. The centrifuge assembly of any preceding clause, wherein each second rotor port is radially closer to axis of rotation than the corresponding first rotor port.

15. A system comprising:
the centrifuge assembly of any preceding clause;
an inlet line fluidically connected upstream to the inlet port;
an outlet line fluidically connected downstream to the outlet port;
a product reservoir fluidically connected to the inlet line via a product outlet valve and outlet line via a product inlet valve;
a buffer reservoir fluidically connected to the inlet line via a buffer outlet valve and the outlet line via a buffer inlet valve;
a waste reservoir fluidically connected to the outlet line via a waste valve; and
a harvest reservoir fluidically connected to the outlet line via a harvest valve.

16. The system of clause 15, further comprising a cut-off valve between the inlet line and the outlet line.

17. A method of operating the centrifuge assembly according to clause 2, the method comprising:
operating the pump in a first direction with the valving in the first configuration to drive fluid to the inlet port then the first rotor port and then the second rotor port;
switching the valving from the first configuration to the second configuration; and
operating the pump in the first direction with the valving in the second configuration to drive fluid to the inlet port then the second rotor port and then the first rotor port.

18. The method of clause 17, wherein the centrifuge assembly further comprises a cell density sensor fluidically connected to the outlet port downstream of the valving, and the method further comprises the steps of:
with the valving in the first configuration sensing an output parameter of the fluid with the cell density sensor; and
with the valving in the second configuration sensing an output parameter of the fluid with the cell density sensor.

19. The method of clause 17 or 18, wherein the fluid is a mixture of one or more of: live cells; dead cells; and/or culture medium, and each second rotor port is radially closer to axis of rotation than the corresponding first rotor port, wherein:
the step of operating the pump in a first direction with the valving in the first configuration to drive fluid to the inlet port then the first rotor port and then the second rotor port is to capture live cells in the rotor and elutriate dead cells and culture medium;
operating the pump in the first direction with the valving in the second configuration to drive fluid to the inlet port then the second rotor port and then the first rotor port is to recover live cells from the rotor.

20. A method of calibrating the centrifuge assembly of clause 6 when dependent on clause 2, wherein the cell density sensor is an optical absorbance sensor and the fluid is a mixture of live cells and dead cells, the method comprising the steps of:
operating the pump in a first direction with the valving in the first configuration to drive the fluid to the inlet port then the first rotor port and then the second rotor port to capture live cells in the rotor and elutriate dead cells and measuring a first optical absorbance; defining a background noise based on the first optical absorbance.

21. The method of clause 20, further comprising the steps of:
increasing the pump speed in the first direction;
identifying a change in the measured optical absorbance; and
comparing the background noise to a second optical absorbance before the change in the measured optical absorbance.

22. The method of clause 17, wherein the cell density sensor is an optical absorbance sensor and the fluid is a mixture of live cells and dead cells, the method further comprising the steps of:
with the valving in the second configuration, subtracting a background noise from a measured optical absorbance to determine the output parameter of the fluid, wherein the background noise is calculated according to the method of clause 20 or 21.

23. A container for a centrifuge comprising:
an elongate stem comprising a first end for attaching to a rotor, and a second opposite end; and
a head portion at the second end of the elongate stem, the head portion radially extending outwardly from the elongate stem and tapering to a point away from the elongate stem.

24. The container of clause 23, wherein the head portion is generally conical tapering from a base to an apex away from the elongate stem, with a base diameter greater than a diameter of the elongate stem.

25. The container of clause 24, wherein the diameter of the elongate stem is between 20% to 30% of the base diameter.

26. The container of clause 24 or 25, wherein the head portion has a cone angle between 70° and 85°.

27. The container of any of clauses 24 to 26, wherein the head portion comprises a first conical shape extending from the base to the apex, and a second conical shape tapering from the base to the elongate stem.

28. The container of any of clauses 24 to 27, wherein the head portion has a head portion length and the first conical shape has a length which is at least 70% of the head portion length.

29. The container of any of clauses 23 to 24, wherein the container has a length, and the elongate stem has a length which is at least 40% of the length of the container.

30. The container of any of clauses 23 to 29, wherein the elongate stem has a length of at least 5 centimetres.

31. The centrifuge assembly of any of clauses 1 to 14, wherein the rotor further comprises a plurality of container mountings for attaching a plurality of containers to the rotor, wherein the centrifuge assembly further comprises:
a plurality of containers according to any of clauses 23 to 30, each container attached to one of the container mountings; and
a pump fluidically connected to drive fluid to each of the containers.

1. A centrifuge assembly comprising:
a rotor, rotationally mounted about an axis of rotation, the rotor comprising a first rotor port and a second rotor port, the second rotor port radially spaced from the first rotor port with respect to the axis of rotation;
an inlet port and an outlet port; and
valving configured to selectively fluidically connect:
the inlet port with the first rotor port and the outlet port with the second rotor port in a first configuration of the valving; or
the inlet port with the second rotor port and the outlet port with the first rotor port in a second configuration of the valving.

2. The centrifuge assembly of claim 1, further comprising a pump fluidically connected to the inlet port upstream of the valving, the pump for driving fluid through the rotor.

3. The centrifuge assembly of claim 2, wherein the pump is configured to only drive fluid in a single direction in a mode of operation.

4. The centrifuge assembly of claim 2, wherein the pump is the only pump in a flow loop defined between the outlet port and the inlet port.

5. The centrifuge assembly of claim 1, further comprising a cell density sensor fluidically connected to the outlet port downstream of the valving.

6. The centrifuge assembly of claim 5, wherein the cell density sensor comprises one or more of:
a capacitance sensor;
an optical absorbance sensor; and/or
a scattered light sensor.

7. The centrifuge assembly of claim 5, wherein the cell density sensor is the only cell density sensor in a flow loop defined between the outlet port and the inlet port.

8. The centrifuge assembly of claim 5, further comprising:
a processor in communication with the cell density sensor to receive a signal, the processor configured to adjust one or more operating parameters of the centrifuge assembly in response to the signal.

9. The centrifuge assembly of claim 7, wherein the operating parameters comprise:
a rotational speed of the rotor;
an acceleration of the rotor;
a deceleration of the rotor;
a temperature of the centrifuge assembly;
a fluid inlet rate to the inlet port; and/or
the configuration of the valving.

10. The centrifuge assembly of claim 1, wherein the valving comprises:
first valving for selectively fluidically connecting the inlet port with the first rotor port or the second rotor port; and
second valving for selectively fluidically connecting the outlet port with the second rotor port or the first rotor port.

11. The centrifuge assembly of claim 10, wherein:
the first valving comprises:
a first valve between the inlet port and the first rotor port; and
a second valve between the inlet port and the second rotor port;
the second valving comprises:
a third valve between the outlet port and the second rotor port; and
a fourth valve between the outlet port and the first rotor port,
preferably wherein:
in the first configuration the first valve is open, the second valve is closed, the third valve is open and the fourth valve is closed; and
in the second configuration the first valve is closed, the second valve is open, the third valve is closed and the fourth valve is open.

12. The centrifuge assembly of claim 1, wherein the rotor comprises a plurality of first rotor ports and second rotor ports, each second rotor port radially spaced from the corresponding first rotor port with respect to the axis of rotation.

13. The centrifuge assembly of claim 12, wherein the valving is configured to selectively fluidically connect:
the inlet port with each first rotor port and the outlet port with each second rotor port in the first configuration of the valving; or
the inlet port with each second rotor port and the outlet port with each first rotor port in the second configuration of the valving.

14. The centrifuge assembly of claim 1, wherein each second rotor port is radially closer to axis of rotation than the corresponding first rotor port.

15. A system comprising:
the centrifuge assembly of claim 1;
an inlet line fluidically connected upstream to the inlet port;
an outlet line fluidically connected downstream to the outlet port;
a product reservoir fluidically connected to the inlet line via a product outlet valve and outlet line via a product inlet valve;
a buffer reservoir fluidically connected to the inlet line via a buffer outlet valve and the outlet line via a buffer inlet valve;
a waste reservoir fluidically connected to the outlet line via a waste valve; and
a harvest reservoir fluidically connected to the outlet line via a harvest valve.

16. The system of claim 15, further comprising a cut-off valve between the inlet line and the outlet line.

17. A method of operating the centrifuge assembly according to claim 2, the method comprising:
operating the pump in a first direction with the valving in the first configuration to drive fluid to the inlet port then the first rotor port and then the second rotor port;
switching the valving from the first configuration to the second configuration; and
operating the pump in the first direction with the valving in the second configuration to drive fluid to the inlet port then the second rotor port and then the first rotor port.

18. The method of claim 17, wherein the centrifuge assembly further comprises a cell density sensor fluidically connected to the outlet port downstream of the valving, and the method further comprises the steps of:
with the valving in the first configuration sensing an output parameter of the fluid with the cell density sensor; and
with the valving in the second configuration sensing an output parameter of the fluid with the cell density sensor.

19. The method of claim 17, wherein the fluid is a mixture of one or more of: live cells; dead cells; and/or culture medium, and each second rotor port is radially closer to axis of rotation than the corresponding first rotor port, wherein:
the step of operating the pump in a first direction with the valving in the first configuration to drive fluid to the inlet port then the first rotor port and then the second rotor port is to capture live cells in the rotor and elutriate dead cells and culture medium; and
operating the pump in the first direction with the valving in the second configuration to drive fluid to the inlet port then the second rotor port and then the first rotor port is to recover live cells from the rotor.

20. A method of calibrating the centrifuge assembly of claim, wherein the centrifuge assembly further comprises a pump fluidically connected to the inlet port upstream of the valving, the pump for driving fluid through the rotor, wherein the cell density sensor is an optical absorbance sensor and the fluid is a mixture of live cells and dead cells, the method comprising the steps of:
operating the pump in a first direction with the valving in the first configuration to drive the fluid to the inlet port then the first rotor port and then the second rotor port to capture live cells in the rotor and elutriate dead cells and measuring a first optical absorbance; and
defining a background noise based on the first optical absorbance.

21. (canceled)

22. (canceled)
